(19) United States
(12) Patent Application Publication
(10) Pub. No.: US 2025/0249766 A1
(43) Pub. Date: Aug. 7, 2025

(54) SELF LOCKING EV CHARGING ADAPTER

(71) Applicant: Tesla, Inc., Austin, TX (US)

(72) Inventors: Mark Westfall, San Francisco, CA (US); Connor Dobson, Palo Alto, CA (US); Ju Hyun Song, Palo Alto, CA (US); David Klawon, Santa Monica, CA (US); Abdullah Yeaser, Mountain View, CA (US); Martin Sukup, San Francisco, CA (US); Andrew David Baglino, Santa Cruz, CA (US)

(21) Appl. No.: 18/856,524

(22) PCT Filed: Apr. 20, 2023
(86) PCT No.: PCT/US2023/019218

§ 371 Date: Oct. 11, 2024

Related U.S. Application Data
(60) Provisional application No. 63/363,380, filed on Apr. 21, 2022.

(51) Int. Cl. B60L 53/16; H01R 13/639; H01R 13/70; H01R 31/06

(52) U.S. Cl. CPC B60L 53/16; H01R 13/6397; H01R 13/70; H01R 31/06; B60L 2270/34

(57) ABSTRACT

An adapter for EV supply equipment (EVSE). The EVSE can have an EVSE connector for charging a PEV. The EVSE connector provides a first connector corresponding to a first charging protocol. The adapter can include a body, a first coupling disposed on the body and configured to engage the first connector, a second coupling disposed on the body and corresponding to a second charging protocol, the body converting the first charging protocol to the second charging protocol, and a lock configured to maintain the body in a locked configuration to the EVSE connector or to the EVSE while allowing the adapter to switch between being locked to the EVSE connector or to the EVSE.

### CROSS-REFERENCE TO RELATED APPLICATIONS

This application claims the benefit of U.S. Provisional Application No. 63/363,380, filed Apr. 21, 2022, the entire disclosure of which is hereby incorporated by reference in its entirety.

### TECHNICAL FIELD

The present disclosure relates generally to charging systems for plug-in electric vehicles (PEV).

### BACKGROUND

Plug-in electric vehicles (PEV) are a class of vehicles that rely on the use of a rechargeable energy pack to drive or contribute to the drive of a vehicle's power train. PEV refers to a superset of vehicles that include plug-in hybrid electric vehicles (PHEV), battery electric vehicles (BEV), and extended range electric vehicles (EREV). Conventional PEVs are configured to be recharged using an EV supply equipment (EVSE). The design of universal EV Supply Equipment (EVSE) requires multiple EV connectors to satisfy competing charging standards such as North American Charging Standard (NACS) or Tesla 5 pin, CCS1, and CHAdeMO standard. This is particularly a challenge in North America where Tesla makes up a large market share and utilizes a proprietary connector geometry. The existing solution to this has traditionally been a two or three cable EV charger, however this adds significant cost and complexity, especially with the advent of liquid cooled charge cables.

### SUMMARY

An aspect is directed to an adapter for EV supply equipment (EVSE), the EVSE having a EVSE connector for charging a PEV (plug-in electric vehicle), the EVSE connector providing a first connector corresponding to a first charging protocol. The adapter comprising a body, a first coupling disposed on the body and configured to engage the first connector, a second coupling disposed on the body and corresponding to a second charging protocol, the body converting the first charging protocol to the second charging protocol, and a lock configured to maintain the body in a locked configuration to the EVSE connector or to the EVSE. The lock allowing the adapter to switch between being locked to the EVSE connector or to the EVSE.

A variation of the aspect above is, wherein the first charging protocol is a Tesla standard (e.g., NACS).

A variation of the aspect above is, wherein the second charging protocol is a CCS1 standard.

A variation of the aspect above is, wherein the second charging protocol is one of CCS2, IEC Type 2, SAE J1772, GB/T, CHAdeMO, or ChaoJia standard.

A variation of the aspect above is, wherein the adapter further comprises one or more switches or sensors configured to determine a state of the EVSE connector, the adapter, and/or the EVSE.

A variation of the aspect above is, wherein the EVSE further comprises a dock, and wherein the lock is configured to maintain the body in a locked configuration to the EVSE connector or to the dock.

A variation of the aspect above is, further comprising a thermal switch.

A variation of the aspect above is, wherein the adapter can be used for either AC or DC charging.

A variation of the aspect above is, wherein the adapter is configured to mechanically convert from the first charging protocol to the second charging protocol.

A variation of the aspect above is, wherein the adapter is configured to electrically convert from the first charging protocol to the second charging protocol.

A variation of the aspect above is, wherein the first coupling and the second coupling are located on opposite ends of the body.

A variation of the aspect above is, wherein the second coupling comprises one or more of a power line connection, a control line connector, and a digital communication bus.

A variation of the aspect above is, wherein the lock is inaccessible to a user to prevent theft and tapering.

A variation of the aspect above is, wherein at least a portion of the lock is disposed on the adapter.

A variation of the aspect above is, wherein the lock comprises a receiver configured to receive a latch.

A variation of the aspect above is, wherein the lock comprises a magnet or ferrous material which can be actuated by a magnet or electromagnet.

A variation of the aspect above is, wherein the latch moves to an unlocked position when the electromagnet is energized.

A variation of the aspect above is, wherein the latch is overmolded with the magnet or the ferrous material.

A variation of the aspect above is, wherein the latch is sprung in the up (locked) position.

A variation of the aspect above is, wherein the latch comprises a chamfered surface configured to allow the EVSE connector to mechanically retract the latch when the EVSE connector is inserted into the first coupling.

A variation of the aspect above is, further comprising a latch position switch configured to detect a state of the latch.

A variation of the aspect above is, wherein the lock comprises a solenoid.

A variation of the aspect above is, wherein the latch comprises a chamfered surface configured to allow the adapter to mechanically retract the latch when the adapter is inserted into the EVSE.

A variation of the aspect above is, further comprising a switch.

A variation of the aspect above is, wherein the switch is configured as a latch position switch.

A variation of the aspect above is, wherein the switch is configured as a thermal switch.

A variation of the aspect above is, wherein the adapter does not comprises a thermistor or a microcontroller.

A variation of the aspect above is, wherein the lock comprises a first lock and a second lock, the first lock selectively engaging the adapter with the EVSE connector, and the second lock selectively engaging the adapter with the EVSE.

A variation of the aspect above is, wherein the adapter is self-locking.

An aspect is directed to an adapter for EV supply equipment (EVSE), the EVSE having a EVSE connector for charging a PEV (plug-in electric vehicle), the EVSE connector providing a connector corresponding to a first charging protocol. The adapter comprising a first coupling configured to engage the connector, a second coupling corresponding to a second charging protocol, and a lock configured to maintain the adapter locked to one of the EVSE connector or to the EVSE while allowing the adapter to switch between being locked to the EVSE connector or to the EVSE.

A variation of the aspect above is, wherein the EVSE compromises a dock.

A variation of the aspect above is, wherein the lock comprises a first lock and a second lock, the first lock selectively engaging the adapter with the EVSE connector, and the second lock selectively engaging the adapter with the dock.

A variation of the aspect above is, wherein the lock comprises a third lock, the third lock selectively engaging one of the first lock or the second lock.

A variation of the aspect above is, wherein the adapter is self-locking.

A variation of the aspect above further comprises a control unit.

A variation of the aspect above is, wherein the adapter can be used for either AC or DC charging.

An aspect is directed to a method for maintaining a locked configuration between an adapter and one of an EV supply equipment (EVSE) connector or an EV supply equipment (EVSE) while allowing the adapter to switch between being locked to the EVSE connector or to the EVSE, the EVSE connector corresponding to a first charging protocol and being configured to engage a first coupling of the adapter, the adapter having a second coupling corresponding to a second charging protocol different than the first charging protocol. The method comprising locking the adapter to the EVSE connector so that the first coupling of the adapter is coupled to the EVSE connector, removing the EVSE connector from the EVSE while the adapter is locked to the EVSE connector, connecting the second coupling of the adapter to a PEV (plug-in electric vehicle), charging the PEV using the second charging protocol, disconnecting the second coupling of the adapter from the PEV, engaging the adapter with the EVSE while the adapter is locked to the EVSE connector, and switching the adapter from being locked to the EVSE connector to being locked to the EVSE so that the EVSE connector can be removed from the EVSE without being coupled to the adapter.

A variation of the aspect above is, wherein the first charging protocol is a NACS standard.

A variation of the aspect above is, wherein the second charging protocol is one of CCS1, CCS2, IEC Type 2, SAE J1772, GB/T, CHAdeMO, or ChaoJia standard.

### BRIEF DESCRIPTION OF THE DRAWINGS

The present inventions are described with reference to the accompanying drawings, in which like reference characters reference like elements, and wherein:

FIG. 1 is a perspective view of an EVSE that includes an adapter configured to stay locked to the EVSE or locked to an EVSE connector while allowing the adapter to switch between being locked to the EVSE or to the EVSE connector.

FIG. 2 is a perspective view of the adapter coupled to the EVSE connector.

FIG. 3 is a cross-section view through the adapter and the EVSE connector of FIG. 2.

FIG. 4A is a cross-section view through the adapter and the dock of FIG. 1.

FIG. 4B is a cross-section view through another embodiment of an adapter similar to the adapter of FIG. 4A except the adapter comprises a third lock between the adapter and the EVSE connector. The third lock further locks the first lock.

FIG. 5 is a signal schematic view of the EVSE connector.

FIG. 6 is a signal schematic view of the adapter.

FIG. 7 is a signal schematic view of the dock on the EVSE.

FIG. 8 is a perspective view of another embodiment of an EVSE that includes an adapter configured to stay locked to the EVSE or locked to an EVSE connector while allowing the adapter to switch between being locked to the EVSE or to the EVSE connector. The EVSE of FIG. 8 is configured for AC charging.

FIG. 9 is a perspective view of the adapter from FIG. 8 coupled to the EVSE connector.

FIG. 10 is a cross-section view through the adapter and the dock of FIG. 8.

FIG. 11A is a cross-section perspective view through the adapter and the dock of FIG. 10 showing an actuator.

FIG. 11B is a backside plan view of a portion of the dock of FIG. 11A showing a motor configured to control the actuator of FIG. 11A.

### DETAILED DESCRIPTION

Generally described, one or more aspects of the present disclosure relate to an adapter which converts one charging interface standard into another. In certain embodiments, the adapter is locked into the EVSE until a customer command requests it to be released. At this point, the adapter is locked onto the handle. The design of the locking mechanism is such that the adapter can only ever be locked onto the handle or onto the EVSE, therefore preventing theft.

Rechargeable energy storage systems are used in many different fields. One type of such implementations is electric vehicles, where a battery pack is used to provide energy to an electric motor that drives one or more wheels of the vehicle. For example, the battery pack is made of one or more cells storing the electric energy until it is used. From time to time, additional energy must be added to the energy storage system. To some extent, this can be done by regenerative braking (or “regen”), which involves converting the vehicle's kinetic energy back into electric form. Another way to replenish the electric energy level is to connect an outside power source (e.g., a DC generator) to the energy storage system. Such a power source is sometimes referred to as electric-vehicle supply equipment (EVSE).

At a general level, each EVSE operates according to the following broad steps: first, connecting equipment (e.g., a plug) is brought in physical contact with the vehicle; then, a logical handshaking process is performed to exchange the necessary information between the vehicle and the EVSE (e.g., how much energy is currently stored in the vehicle, and/or the capacity of the EVSE); finally, one or more switches in the vehicle are closed so that there is electrical connection between the EVSE's charging conduit and the vehicle's battery system. This last step is the point when electric energy begins to flow from the EVSE into the vehicle for recharging the battery pack.

More particularly, however, each type of EVSE can operate according to any of multiple different protocols for charging of electric vehicles. One such example is CCS1. CCS1 is based on the SAE J1772 standard which was established by SAE International. Another example of a charging protocol is CHAdeMO, which was established by a number of Japanese companies. Another standard is the North American Charging Standard (NACS) or Tesla 5 pin standard. Some electric vehicles (or other rechargeable electric equipment) operate according to another charging protocol than the examples mentioned above.

In certain embodiments, the system comprises a first lock for locking the adapter to the charge handle and a second lock for locking the adapter to the dock. In certain embodiments, the locks for these two locking mechanisms may be a single two position mechanism or two separate mechanisms. In certain embodiments, the first lock and/or the second lock is actuated by a solenoid. In certain embodiments, the first lock and/or the second lock is actuated by a magnet or electromagnet. In certain embodiments, the first lock and/or the second lock is actuated by a motor.

In certain embodiments, the system comprises a series of switches or sensors to determine the state of the handle, adapter, and dock. In certain embodiments, the sensors may be utilized for theft prevention or safety (i.e., in order to ensure the adapter is fully locked to the handle before charging begins).

In certain embodiments, the system comprises a control unit configured to perform one or more of the following functions: authenticate the user either via credit card payment, NFC, or App; allow the user to select which charging connector they want to charge with (native handle or adapter); lock the adapter to the handle; and unlock the adapter from the dock. One or more of these functions can be done automatically, through an app, or via a physical button.

In certain embodiments, the adapter comprises a thermal switch. In certain embodiments the thermal switch is in series with a resistor on one of the low voltage signal lines (e.g., the proximity line, the pilot line, etc.). In this way, the EVSE is sent to an unknown state which allows the EVSE to reduce power. This can be advantageous because the adapter is always coupled to the EVSE, so the EVSE can recognize unique proximity states and act on them. This also allows the EVSE to ‘sense’ temperature without the use of a microcontroller or thermistor inside the adapter.

In certain embodiments, the system can be used for both AC and DC charging, both public and private, at all power levels. For home charging, user authentication is not required and may be disabled.

Features of the system can include (1) Locking/Unlocking of the adapter to EVSE and EVSE connector (e.g., charge handle); (2) lock (e.g., sprung lock) such that the adapter/dock do not need continuous power to exist in the locked/unlocked state; (3) Sensing mechanisms for determining adapter/handle lock state; (4) Payment/Authentication Control Unit for locking/unlocking adapter; and (5) temperature switch.

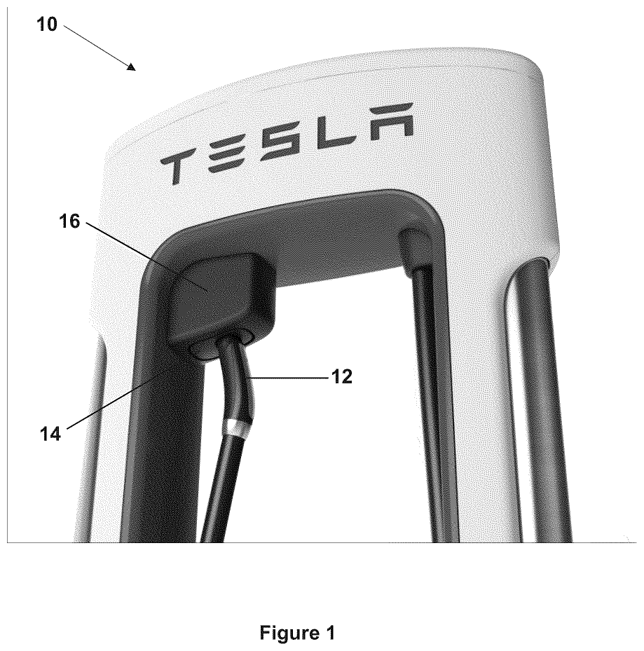

FIG. 1 is a perspective view of an EVSE 10. The current description focuses on certain components involved in performing the charging protocol(s), and, for clarity, some other components are therefore not illustrated. For example, the EVSE 10 can be implemented in a charging station (e.g., located along a highway or in another public space) or at a home, and an electric vehicle can be an electric car of any type (e.g., a roadster, coupe, sedan, wagon, sport utility vehicle, truck or minivan). The EVSE 10 can be configured for DC or AC charging.

The EVSE 10 includes an EVSE connector 12 and an adapter 14. In certain embodiments, the EVSE connector 12 comprises a first connector 20. The first connector 20 is configured to engage with a first PEV when not utilizing the adapter 14.

The adapter 14 is configured to stay locked to the EVSE 10 and can only be removed from the EVSE 10 by the user if the adapter 14 is locked to the EVSE connector 12. For example, in certain embodiments, the adapter 14 is locked to the first connector 20 of the EVSE connector 12 when the adapter 14 is removed from the EVSE 10.

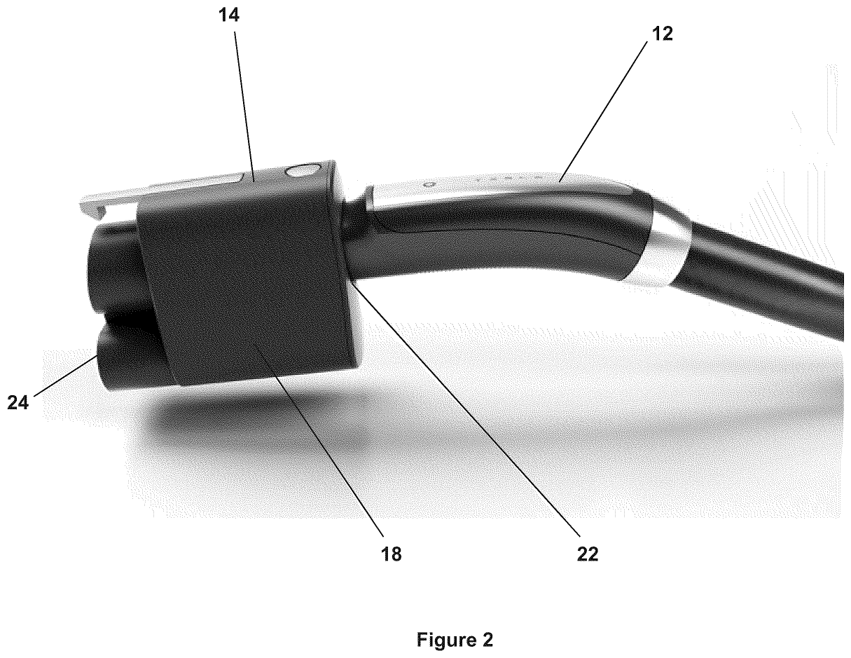

In certain embodiments, the EVSE connector 12 can satisfy a plurality of competing charging standards or protocols (e.g., NACS, CCS1, CCS2, IEC Type 2, SAE J1772, GB/T, CHAdeMO, and ChaoJi). For example, the EVSE connector 12 and the adapter 14 can allow the EVSE 10 to charge using at least two charging standards. In certain embodiments, the EVSE 10 comprises a first adapter 14 for “CCS1/(Tesla or NACS)” (See FIG. 2). In this example, the EVSE 10 adapts between the respective CCS1 and Tesla Motors (NACS) charging standards. Generally, the labels “CCS1” and “Tesla” in this and other examples are for illustrative purposes only. In other implementations, adaptation can be done between charging protocols that include only one, or none, of the CCS1 and Tesla Motors (NACS) charging protocols.

In certain embodiments, the EVSE 10 can comprises more than one adapter 14. For example, the EVSE 10 can comprise a first interprotocol adapter for “CCS1/(Tesla or NACS)” and a second interprotocol adapter for “CHAdeMO/(Tesla or NACS).” The user can select between the first and second adapters. Of course, the disclosure is not limited to two adapters can include any number of adapters.

In certain embodiments, the EVSE 10 comprises a dock 16. The dock 16 can be configured to provide a receptacle for receiving the adapter 14. In certain embodiments, the user can command whether the adapter 14 and the EVSE connector 12 stay coupled together when the EVSE connector 12 is removed from the EVSE 10 or if the EVSE connector 12 separates from the adapter 14 to leave the adapter 14 coupled to the dock 16.

FIG. 2 is a perspective view of the adapter 14 when coupled to the EVSE connector 12. In certain embodiments, the adapter 14 comprises a body 18. In certain embodiments, the body 18 comprises a first coupling 22. In certain embodiments, the first coupling 22 is configured to be engaged by the first connector 20 of the EVSE connector 12. In certain embodiments, the first coupling 22 corresponds to a first charging protocol (e.g., NACS or Tesla 5 pin). In certain embodiments, the body 18 converts the first charging protocol to a second charging protocol.

In certain embodiments, the body 18 comprises a second coupling 24. In certain embodiments, the second coupling 24 is configured to engage with a second PEV that requires a different charging protocol than the first PEV. In certain embodiments, the second coupling 24 corresponds to a second charging protocol (e.g., CCS1, CCS2, IEC Type 2, SAE J1772, GB/T, CHAdeMO, and ChaoJi) that is different than the first charging protocol. In certain embodiments, the body 18 converts the first charging protocol to the second charging protocol. In this way, in certain embodiments, the adapter 14 can mechanical and/or electrically convert from the first charging protocol to the second charging protocol. For example, in certain embodiments, the EVSE connector 12 (with and without the adapter 14) is configured to charge PEVs (plug-in electric vehicles) using more than one charging protocols.

In certain embodiments, the first coupling 22 and the second coupling 24 are mounted on the housing 18. The respective couplings and the housing 18 of the adapter 14 can be manufactured from any appropriate material using any suitable technique. In some implementations, the component(s) can be molded (as one or more pieces) from plastic or another polymer. For example, and without limitation, the first and second couplings 22, 24 can be manufactured as separate parts that are then joined to the main body housing 18. The circuitry (e.g., the components of the adapter 14) can then be located essentially inside the housing 18, with contacts extending through the respective first and second couplings 22, 24 for connecting with external equipment (e.g., the EVSE connector 12 and PEV).

In this example, the first coupling 22 and the second coupling 24 are located on essentially opposite ends of the adapter 14. This configuration can be convenient for using the adapter 14, in that the second coupling 24 can be fitted into a charging port of the equipment to be charged (e.g., PEV) and the first coupling 22 provides an interface for attaching (e.g., plugging in) the EVSE connector 12.

In the illustrated embodiment, the first connector 20 on the EVSE connector 12 is compatible with the charging port used on certain Tesla PEVs. The second coupling 24 on the adapter 14 can be configured to conform to any of the charging protocols. In the illustrated embodiment, the second coupling 24 on the adapter 14 is compatible with the charging port used on certain PEVs that require the CCS1 charging protocol.

In certain embodiments, at a high level, the second coupling 24 can include power line connections, control line connectors, and a digital communication bus. More specifically, in certain embodiments, the second coupling 24 can include high-voltage power supplies coupled to a DC power source of the EVSE 10, a ground connector, charger start/stop connectors, a proximity connector, a charging start/stop connector, and/or a controller area network (CAN) connector.

The EVSE 10 can also include a lock control that is used for physically locking the EVSE connector 12 (e.g., the charging plug thereof) and the adapter 14 to each other. For example, in certain embodiments, the EVSE 10 can include a processor that controls one or more of the EVSE's 10 and/or the adapter's 14 operations. In certain embodiments, the processor performs interpreter functions between the EVSE 10 and the PEV, and controls and monitors low-voltage inputs/outputs and communication busses.

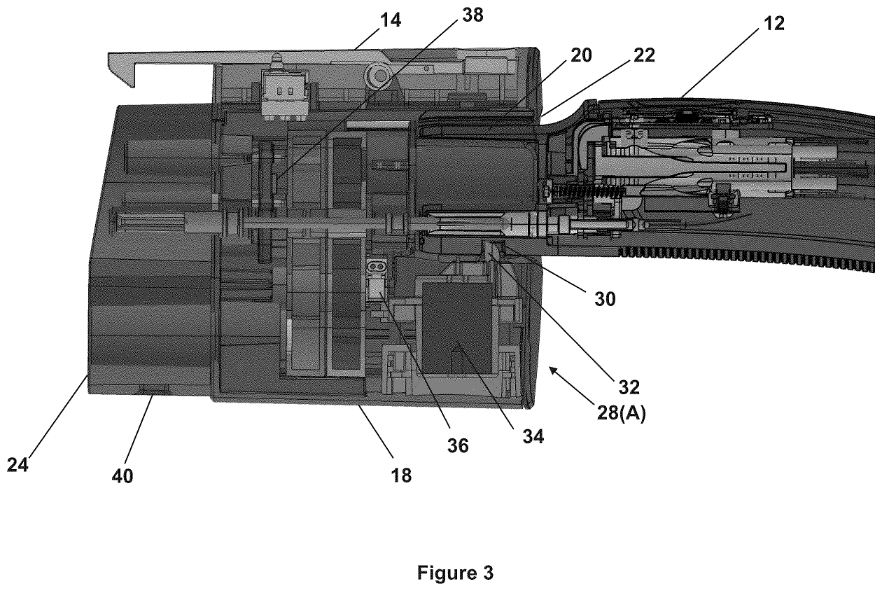

FIG. 3 is a cross-section view through the adapter 14 and the EVSE connector 12 of FIG. 2. In the illustrated embodiment, the adapter 14 is engaged with the EVSE connector 12. In the exemplary illustrated configuration, the EVSE 10 is configured to charge the PEV using the CCS1 standard.

In certain embodiments, the system comprise one or more locks 28. In certain embodiments, the one or more locks 28 are inaccessible to the user to prevent theft and tapering. In certain embodiments, a first lock 28(A) of the one or more locks 28 selectively locks the adapter 14 to the EVSE connector 12. In the illustrated embodiment of FIG. 3, the first lock 28(A) comprises a receiver 30 configured to receive a latch 32. In certain embodiments, the first lock 28(A) comprises a magnet 34 (e.g., permanent magnet) or ferrous material. In certain embodiments, the magnet 34 is actuated by a magnet or electromagnet in the dock 16. In certain embodiments, the latch 32 is overmolded with the magnet 34 or ferrous material. In certain embodiments, the latch 32 is sprung in the up (locked) position. In certain embodiments, the latch 32 moves to the unlocked position when the magnet 34 is actuated. In this way, the magnet 34 can be actuated to pull the latch 32 down.

In certain embodiments, the latch 32 includes a chamfered surface configured to allow the EVSE connector 12 to mechanically retract the latch 32 when the EVSE connector 12 is inserted into the adapter 14. In this way, the EVSE connector 12 can be inserted into the adapter 14 even when the latch 32 is in the locked position. In certain embodiments, a latch position switch 36 detects the state of the latch 32. Of course the first lock 28(A) is not limited to the illustrated embodiment and can have any other configuration known to a person having ordinary skill in the art.

In certain embodiments, the adapter 14 comprises a thermal switch 38. In certain embodiments, the thermal switch 38 is configured to protect the adapter 14 from damage due to overheating during charging.

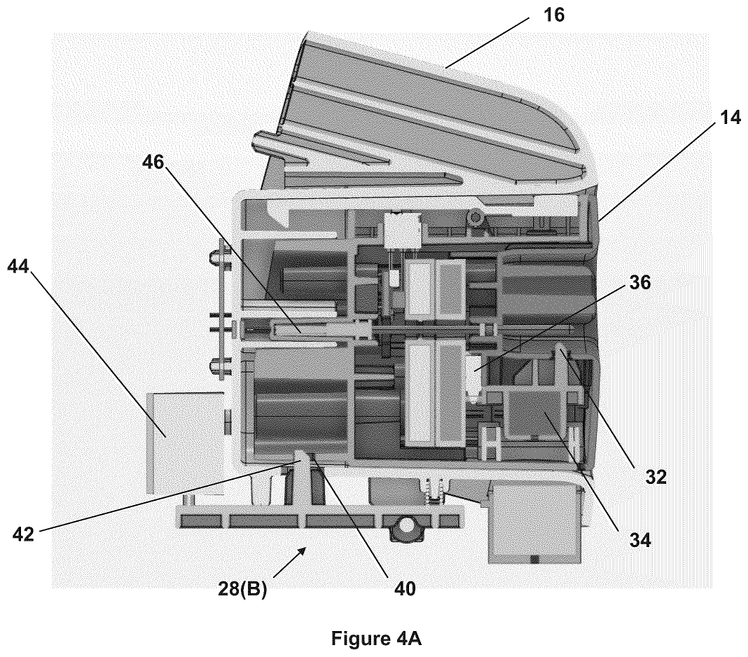

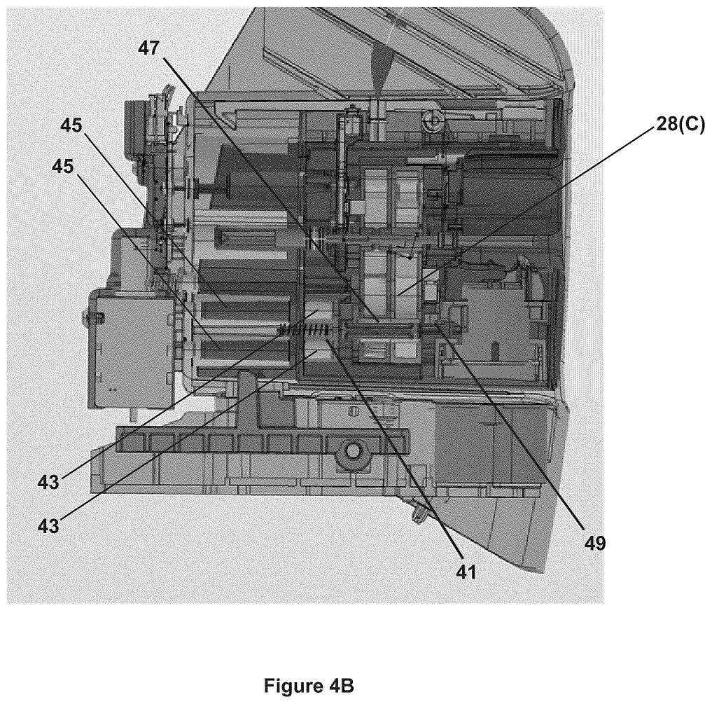

FIG. 4A is a cross-section view through the adapter 14 and the dock 16 of FIG. 1. In certain embodiments, a second lock 28(B) of the one or more locks 28 selectively locks the adapter 14 to the dock 16. In the illustrated embodiment of FIG. 4A, the second lock 28(B) comprises a receiver 40 configured to receive a latch 42. In certain embodiments, the second lock 28(B) is driven by a solenoid 44. In certain embodiments, the latch 42 is sprung in the up (locked) position. In certain embodiments, the latch 42 moves to the unlocked position by the solenoid 44. In this way, the solenoid 44 can be actuated to pull the latch 42 down. In certain embodiments, the latch 42 pivots between the locked and unlocked positions.

In certain embodiments, the latch 42 includes a chamfered surface configured to allow the adapter 14 to mechanically retract the latch 42 when the adapter 14 (and EVSE connector 12) is inserted into the dock 16. In this way, the adapter 14 can be inserted into the dock 16 even when the latch 42 is in the locked position. In certain embodiments, a latch position switch (not shown) detects the state of the latch 42. Of course the second lock 28(B) is not limited to the illustrated embodiment and can have any other configuration known to a person having ordinary skill in the art. In certain embodiments, the adapter 14 comprises a low voltage signal pass through 46 for handle or adapter presence detection.

FIG. 4B is a cross-section view through another embodiment of an adapter 14 similar to the adapter 14 of FIG. 4A except the adapter 14 comprises a third lock 28(C) between the adapter 14 and the EVSE connector 12. In certain embodiments, the third lock 28(C) further locks the first lock 28(A) when the first lock 28(A) is locked to the EVSE connector 12. In this way, the third lock 28(C) provides an independent locking mechanism to prevent the first lock 28(A) from inadvertently allowing the adapter 14 to disengage from the EVSE connector 12 when the adapter 14 is removed from the dock 16.

In certain embodiments, the third lock 28(C) comprises a locking pin 47. The locking pin 47 can be configured to selectively engage with a portion of the first lock 28(A) when in a first position. In the illustrated embodiment, the locking pin 47 can selectively engage with a lip 49 of the first lock 28(A) by sliding the locking pin 47 in a direction towards the EVSE connector 12. In this way, the locking pin 47 blocks the lip 49 of the first lock 28(A) from moving in a downward direction preventing the latch 32 from disengaging from the receiver 30.

In certain embodiments, the locking pin 47 is biased towards the first position by a spring 41. In this way, the locking pin 47 is passively sprung into the first position when the adapter 14 is undocked preventing the latch 32 from disengaging from the receiver 30. In certain embodiments, the locking pin 47 is moved to a retracked or second position by one or more magnets. For example, in the illustrated embodiment, one or more pairs of magnets 43, 45 are configured to retract the locking pin 47 when the adapter 14 is docked to allow the lip 49 of the first lock 28(A) to move in a downward direction allowing the latch 32 to disengage from the receiver 30.

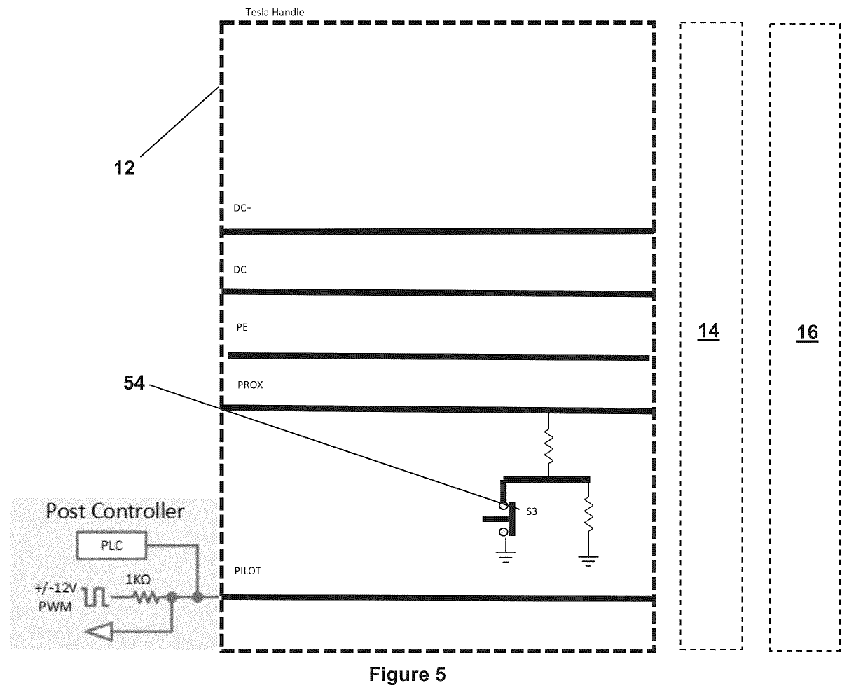

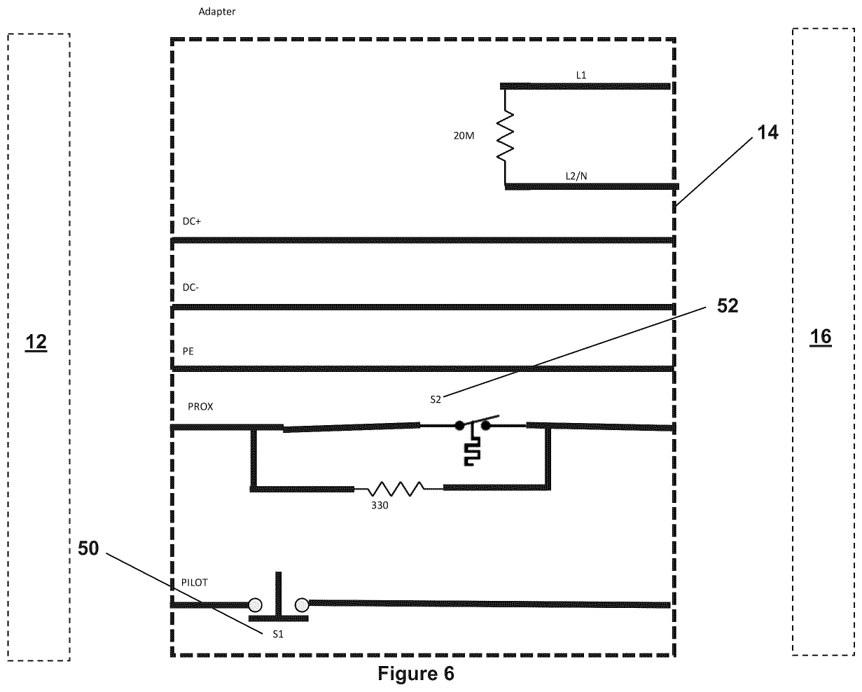

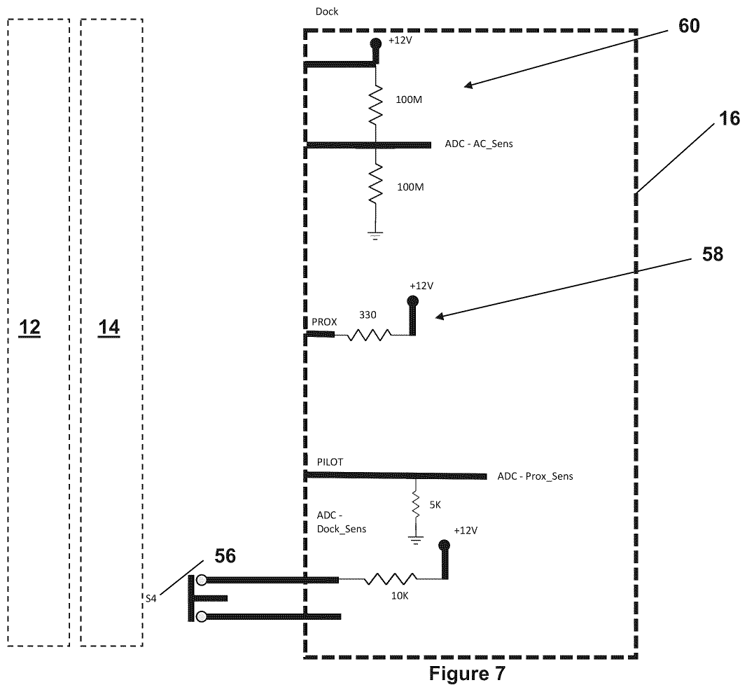

FIG. 5 is a signal schematic view of the EVSE connector 12. FIG. 6 is a signal schematic view of the adapter 14. FIG. 7 is a signal schematic view of the dock 16 on the EVSE 10. In certain embodiments, the EVSE connector 12, the adapter 14, and/or the dock 16 comprise one or more of the illustrated signal paths. Of course, the embodiments disclosed herein are not limited to the illustrated signal schematics and can include any of the signal schematic.

In certain embodiments, the adapter 14 comprises switch (S1) 50. In certain embodiments, the switch (S1) 50 is configured as the latch position switch 36 illustrated in FIG. 3. In certain embodiments, the adapter 14 comprises switch (S2) 52. In certain embodiments, the switch (S2) 52 is configured as the thermal switch 38 illustrated in FIG. 3. In certain embodiments, the switch (S2) 52 allows the EVSE 10 to recognize a ‘thermal foldback” state in the adapter 14 without using thermistors or microcontrollers in the adapter 14.

In certain embodiments, the EVSE connector 12 comprises switch (S3) 54. In certain embodiments, the switch (S3) 54 is configured as a handle button proximity circuit. In certain embodiments, the switch (S3) 54 signals end of charge.

In certain embodiments, the dock 16 comprises switch (S4) 56. In certain embodiments, the switch (S4) is configured as a J1772 latch sense switch. In certain embodiments, the switch (S4) is required by the CCS1 standard. In certain embodiments, the dock 16 comprises a proximity passthrough 58. In certain embodiments, the proximity passthrough 58 allows a determination of the EVSE connector 12 inserted into the adapter 14. In certain embodiments, when the EVSE connector 12 is inserted into the adapter 14, the 150+330 resistor pulls the system voltage down.

In certain embodiments, unused adaptor pins are repurposed for a sense circuit 60. In certain embodiments, the sense circuit 60 determines whether or not the adapter 14 is in the dock 16, whether or not the dock 16 is present.

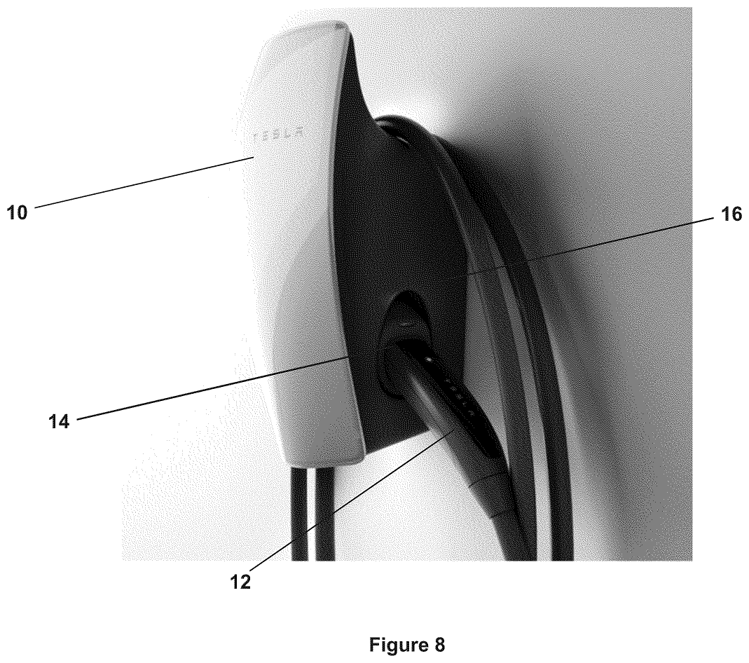

FIG. 8 is a perspective view of another embodiment of an EVSE 10 that includes an adapter 14 configured to stay locked to the EVSE 10 or locked to an EVSE connector 12 while allowing the adapter 14 to switch between being locked to the EVSE 10 or to the EVSE connector 12. The EVSE 10 of FIG. 8 is configured for AC charging.

The EVSE 10 includes an EVSE connector 12 and an adapter 14. In certain embodiments, the EVSE connector 12 comprises a first connector 20. The first connector 20 is configured to engage with a first PEV when not utilizing the adapter 14.

The adapter 14 is configured to stay locked to the EVSE 10 and can only be removed from the EVSE 10 by the user if the adapter 14 is locked to the EVSE connector 12. For example, in certain embodiments, the adapter 14 is locked to the first connector 20 of the EVSE connector 12 when the adapter 14 is removed from the EVSE 10.

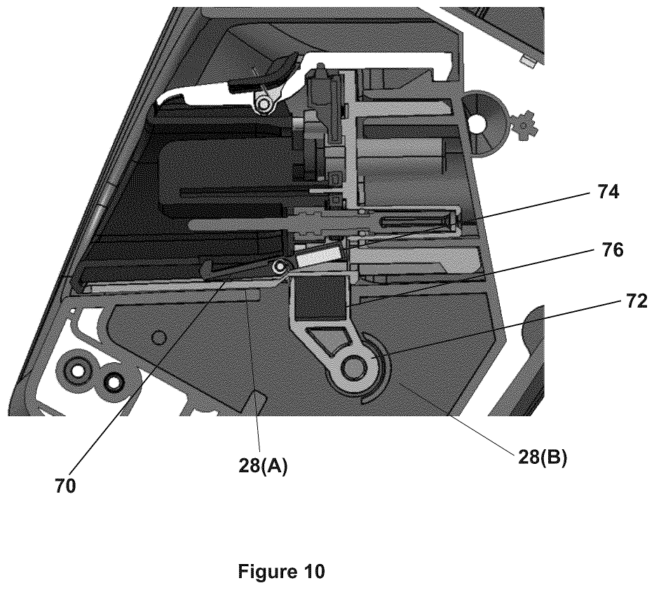

In certain embodiments, the EVSE connector 12 can satisfy a plurality of competing charging standards or protocols (e.g., NACS, CCS1, CCS2, IEC Type 2, SAE J1772, GB/T, CHAdeMO, and ChaoJi). For example, the EVSE connector 12 and the adapter 14 can allow the EVSE 10 to charge using at least two charging standards. In certain embodiments, the EVSE 10 comprises a first adapter 14 for “J1772/NACS” (See FIG. 10). In this example, the EVSE 10 adapts between the respective J1772 and NACS protocols. Generally, the labels “J1772” and “NACS” in this and other examples are for illustrative purposes only. In other implementations, adaptation can be done between charging protocols that include only one, or none, of the J1772 and NACS protocols.

In certain embodiments, the EVSE 10 can comprises more than one adapter 14. For example, the EVSE 10 can comprise a first interprotocol adapter for “J1772/NACS” and a second interprotocol adapter for “CHAdeMO/NACS.” The user can select between the first and second adapters. Of course, the disclosure is not limited to two adapters can include any number of adapters.

In certain embodiments, the EVSE 10 comprises a dock 16. The dock 16 can be configured to provide a receptacle for receiving the adapter 14. In certain embodiments, the dock 16 is integral with the EVSE 10. In certain embodiments, the user. can command whether the adapter 14 and the EVSE connector 12 stay coupled together when the EVSE connector 12 is removed from the EVSE 10 or if the EVSE connector 12 separates from the adapter 14 to leave the adapter 14 coupled to the dock 16.

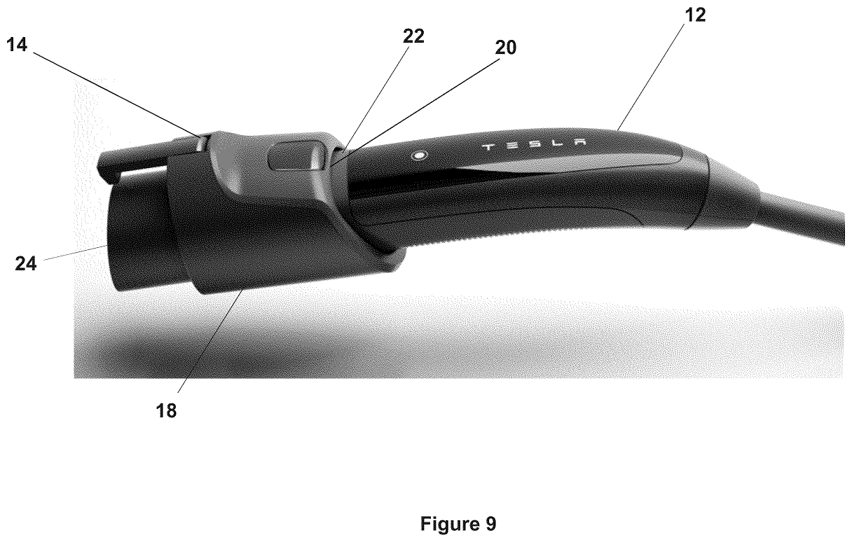

FIG. 9 is a perspective view of the adapter 14 from FIG. 8 coupled to the EVSE connector 12. In certain embodiments, the adapter 14 comprises a body 18. In certain embodiments, the body 18 comprises a first coupling 22. In certain embodiments, the first coupling 22 is configured to be engaged by the first connector 20 of the EVSE connector 12. In certain embodiments, the first coupling 22 corresponds to a first charging protocol (e.g., NACS). In certain embodiments, the body 18 converts the first charging protocol to a second charging protocol.

In certain embodiments, the body 18 comprises a second coupling 24. In certain embodiments, the second coupling 24 is configured to engage with a second PEV that requires a different charging protocol than the first PEV. In certain embodiments, the second coupling 24 corresponds to a second charging protocol (e.g., J1772) that is different than the first charging protocol. In certain embodiments, the body 18 converts the first charging protocol to the second charging protocol.

The EVSE 10 can also include a lock control that is used for physically locking the EVSE connector 12 (e.g., the charging plug thereof) and the adapter 14 to each other. For example, in certain embodiments, the EVSE 10 can include a processor that controls one or more of the EVSE's 10 and/or the adapter's 14 operations.

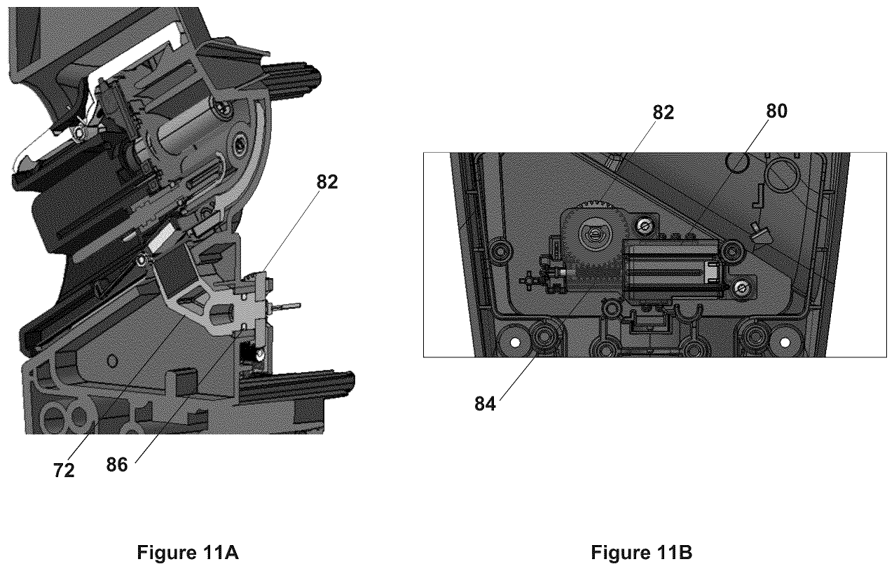

FIG. 10 is a cross-section view through the adapter 14 and the dock 16 of FIG. 8. FIG. 11A is a cross-section perspective view through the adapter 14 and the dock 16 of FIG. 10 showing an actuator 72. FIG. 11B is a backside plan view of a portion of the dock 16 of FIG. 11A showing a motor 80 configured to control the actuator 72 of FIG. 11A. In the illustrated embodiment, the adapter 14 is engaged with the EVSE 10. In the exemplary illustrated configuration, the EVSE 10 is configured to charge the PEV using the J1772 standard.

In certain embodiments, the system comprise one or more locks 28. In certain embodiments, the one or more locks 28 are inaccessible to the user to prevent theft and tapering. In certain embodiments, a first lock 28(A) of the one or more locks 28 selectively locks the adapter 14 to the EVSE connector 12. In the illustrated embodiment of FIG. 10, the first lock 28(A) comprises a receiver 30 on the EVSE connector 12 configured to receive a latch 70. In certain embodiments, the first lock 28(A) comprises a plurality of magnets 74, 76 (e.g., permanent magnet) or ferrous material. In certain embodiments, the magnets 74, 76 are arranged relative to each other so as to create a force of repulsion (e.g., N poles facing each other). The force of repulsion can cause the latch 70 of the first lock 28(A) to rotate in a counter-clockwise direction around a pivot so as to not engage with the EVSE connector 12. In certain embodiments, the latch 70 is overmolded with the magnet 74 or ferrous material. In certain embodiments, the latch 70 is sprung in the up (locked) position (e.g., clockwise) in the absence of the force of repulsion. In this way, the force of repulsion between the magnets 74, 76 pulls the latch 70 down. Of course the first lock 28(A) is not limited to the illustrated embodiment and can have any other configuration known to a person having ordinary skill in the art.

In certain embodiments, a second lock 28(B) of the one or more locks 28 selectively locks the adapter 14 to the dock 16. In the illustrated embodiment of FIG. 10, the second lock 28(B) comprises an actuator 72. The actuator 72 is illustrated in a locked position in FIG. 10. When in the locked position, the actuator 72 locks the adapter 14 to the dock 16. In certain embodiments, the actuator 72 further prevents the latch 70 from locking to the adapter 14 when the actuator 72 is locking the adapter 14 to the dock 16.

In certain embodiments, the second lock 28(B) is driven by a motor 80. In certain embodiments, the motor 80 drives a worm gear 84 which itself drives a helical gear 82 of the actuator 72. In certain embodiments, the actuator 72 is rotated in a counterclockwise direction to an unlocked position by the motor 80. In this way, the motor 80 can rotate the actuator 71 down releasing the adapter 14. In certain embodiments, the actuator 72 pivots between the locked and unlocked positions.

In certain embodiments, the magnet 76 is coupled to the actuator 72. In this way, when the actuator 72 rotates to the unlocked position, the magnet 76 moves away from the magnet 74 reducing or eliminating the force of repulsion between the magnets 74, 76. As the force of repulsion is reduced, the latch 70 rotates in a clockwise direction to lock to the EVSE connector 12. Of course the second lock 28(B) is not limited to the illustrated embodiment and can have any other configuration known to a person having ordinary skill in the art. In certain embodiments, an O-ring 86 is provided between the actuator 72 and the EVSE 10.

This description mentions electric cars as examples of equipment that uses rechargeable energy storage systems. However, the description likewise applies to rechargeable energy storage systems used in any other type of equipment or device, including, but not limited to, motorcycles, scooters, buses, trams, trains, boats, lighting equipment, tools and mobile electronic devices, to name just a few examples.

Also, battery packs are mentioned as examples of rechargeable energy storage systems. Rechargeable energy storage systems can include any of multiple different rechargeable configurations and cell chemistries including, but not limited to, lithium ion (e.g., lithium iron phosphate, lithium cobalt oxide, other lithium metal oxides, etc.), lithium ion polymer, nickel metal hydride, nickel cadmium, nickel hydrogen, nickel zinc, silver zinc, or other chargeable high energy storage type or configuration, to name just a few examples.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed embodiments. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure.

Expressions such as “including”, “comprising”, “incorporating” “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application.

1. An adapter for EV supply equipment (EVSE), the EVSE having a EVSE connector for charging a PEV (plug-in electric vehicle), the EVSE connector providing a first connector corresponding to a first charging protocol, comprising:
a body;
a first coupling disposed on the body and configured to engage the first connector;
a second coupling disposed on the body and corresponding to a second charging protocol, the body converting the first charging protocol to the second charging protocol; and
a lock configured to maintain the body in a locked configuration to the EVSE connector or to the EVSE, the lock allowing the adapter to switch between being locked to the EVSE connector or to the EVSE, the lock being inaccessible to a user to prevent theft and tampering.

2. The adapter of claim 1, wherein the first charging protocol is a NACS standard.

3. The adapter of claim 1, wherein the second charging protocol is a CCS1 standard.

4. The adapter of claim 1, wherein the second charging protocol is one of CCS2, IEC Type 2, SAE J1772, GB/T, CHAdeMO, or ChaoJia standard.

5. The adapter of claim 1, wherein the adapter further comprises one or more switches or sensors configured to determine a state of the EVSE connector, the adapter, and/or the EVSE.

6. The adapter of claim 1, wherein the EVSE further comprises a dock, and wherein the lock is configured to maintain the body in a locked configuration to the EVSE connector or to the dock.

7. (canceled)

8. (canceled)

9. (canceled)

10. (canceled)

11. The adapter of claim 1, wherein the first coupling and the second coupling are located on opposite ends of the body.

12. The adapter of claim 1, wherein the second coupling comprises one or more of a power line connection, a control line connector, and a digital communication bus.

13. (canceled)

14. The adapter of claim 1, wherein at least a portion of the lock is disposed on the adapter.

15. The adapter of claim 1, wherein the lock comprises a receiver configured to receive a latch.

16. The adapter of claim 15, wherein the lock comprises a magnet or ferrous material which can be activated by a magnet or an electromagnet.

17. (canceled)

18. (canceled)

19. (canceled)

20. (canceled)

21. The adapter of claim 1, further comprising a latch position switch configured to detect a state of the latch.

22. (canceled)

23. (canceled)

24. The adapter of claim 1, further comprising a switch.

25. (canceled)

26. (canceled)

27. (canceled)

28. (canceled)

29. (canceled)

30. An adapter for EV supply equipment (EVSE), the EVSE having a EVSE connector for charging a PEV (plug-in electric vehicle), the EVSE connector providing a connector corresponding to a first charging protocol, comprising:
a first coupling configured to engage the EVSE connector;
a second coupling corresponding to a second charging protocol; and
a lock configured to maintain the adapter locked to one of the EVSE connector or to the EVSE while allowing the adapter to switch between being locked to the EVSE connector or to the EVSE, the lock being inaccessible to a user to prevent theft and tampering.

31. The adapter of claim 30, wherein the EVSE compromises a dock.

32. The adapter of claim 31, wherein the lock comprises a first lock and a second lock, the first lock selectively engaging the adapter with the EVSE connector, and the second lock selectively engaging the adapter with the dock.

33. The adapter of claim 32, wherein the lock comprises a third lock, the third lock selectively engaging one of the first lock or the second lock.

34. The adapter of claim 30, wherein the adapter is self-locking.

35. The adapter of claim 30, further comprising a control unit.

36. The adapter of claim 30, wherein the adapter can be used for either AC or DC charging.

37. (canceled)

38. (canceled)

39. (canceled)
